(19) United States
(12) Patent Application Publication
(10) Pub. No.: US 2013/0232198 A1
(43) Pub. Date: Sep. 5, 2013

(54) System and Method for Peer-to-Peer Distribution of Media Exposure Data

(71) Applicant: ARBITRON INC., Columbia, MD (US)

(72) Inventor: Michael Tenbrock, Columbia, MD (US)

(73) Assignee: ARBITRON INC., Columbia, MD (US)

(21) Appl. No.: 13/728,068

(22) Filed: Dec. 27, 2012

Related U.S. Application Data
(63) Continuation-in-part of application No. 12/643,647, filed on Dec. 21, 2009.

(51) Int. Cl. H04L 29/08

(52) U.S. Cl. CPC H04L 67/22
USPC 709/204

(57) ABSTRACT

Systems and methods for operating an anonymous peer-to-peer (“P2P”) privacy panel for audience measurement is disclosed. A plurality of processing devices are configured to record and process research data pursuant to a research operation. Each of the users associated with each processing devices provide user data to a central site, where the user data includes demographic information, previous media exposure data, and other data. In accordance with user data, a customized P2P network is created where media exposure data including audio codes, signatures and data objects is obfuscated and communicate among portable devices in the network. By utilizing a P2P network, together with obfuscation techniques, panelist privacy is greatly increased.

### RELATED APPLICATIONS

The present application claims priority to U.S. patent application Ser. No. 12/643,647 titled “Peer-to-Peer Privacy Panel for Audience Measurement,” filed Dec. 21, 2009, which is assigned to the assignee of the present application and is incorporated by reference in its entirety herein.

### TECHNICAL FIELD

The present disclosure relates to systems and processes for identifying analog and digital media content for panelists participating in an audience measurement survey, and for providing a distributed network for privacy on the resulting measurements obtained for each panelist.

### BACKGROUND INFORMATION

There is considerable interest in measuring the usage of media data accessed by an audience via a network or other source. In order to determine audience interest and what audiences are being presented with, a user's system may be monitored for discrete time periods while connected to a network, such as the Internet. Large amounts of data may be compiled in a relatively short period of time, requiring substantial processing, bandwidth and storage resources.

There is also considerable interest in providing market information to advertisers, media distributors and the like which reveals the demographic characteristics of such audiences, along with information concerning the size of the audience. Further, advertisers and media distributors would like the ability to produce custom reports tailored to reveal market information within specific parameters, such as type of media, user demographics, purchasing habits and so on. In addition, there is substantial interest in the ability to monitor media audiences on a continuous, real-time basis. This becomes very important for measuring streaming media data accurately, because a snapshot or event generation fails to capture the ongoing and continuous nature of streaming media data usage.

Based upon the receipt and identification of media data, the rating or popularity of various web sites, channels and specific media data may be estimated. It would be advantageous to determine the popularity of various web sites, channels and specific media data according to the demographics of their audiences in a way which enables precise matching of data representing media data usage with user demographic data.

Multimedia streaming delivers a steady stream of video and/or audio over the network connection. For instance, the stream may include multiple independent multimedia segments such as advertising. Further, the stream may be associated with a particular network resource such as a web page that offers content tied to the streaming media data. There are also multiple protocols and delivery technologies that result in many different types of streaming encoding, servers and players. Also, the streaming media data is often associated with additional media data having diverse formats such as but not limited to HTML, e-mail, and instant messaging.

The options for accessing and presenting media data, as well as the means for delivering media data develop and evolve at ever greater rates. For many years, over-the-air radio and television broadcasting distributed listening and viewing data in fixed formats and in long-established and well-defined channels. More recently, systems and methods for measuring media data have been developed, where the media data is delivered in many more formats through numerous communication systems and protocols which continually evolve. These systems allow for the monitoring of more sources of media data, along with a multitude of devices and user agents for accessing and presenting media data. Exemplary systems are disclosed in co-pending U.S. patent application Ser. No. 10/205,510 to Hebeler et al., titled “Media Data Usage Measurement and Reporting Systems and Methods”, filed Jul. 26, 2002, U.S. patent application Ser. No. 11/643,159 to Neuhauser et al., titled “Methods and Systems for Gathering Research Data for Media From Multiple Sources”, filed Dec. 20, 2006, and U.S. patent application Ser. No. 11/805,075 to Neuhauser, titled “Gathering Research Data”, filed May 21, 2007. Each of the aforementioned patent applications are incorporated by reference in their entirety herein.

Additionally, platform-independent techniques for measuring media exposure have become more popular recently, particularly in the field of audio signatures or “fingerprints.” Such techniques typically involve the use of a reference signature database, which contains a reference signature for each program signal the receipt of which, and exposure to which, is to be measured. Before the program signal is broadcast, these reference signatures are created by measuring the values of certain features of the program signal and creating a feature set or “signature” from these values, commonly termed “signature extraction”, which is then stored in the database. Later, when the program signal is broadcast, signature extraction is again performed, and the signature obtained is compared to the reference signatures in the database until a match is found and the program signal is thereby identified.

Suitable techniques for extracting signatures from audio data are disclosed in U.S. Pat. No. 5,612,729 to Ellis, et al. and in U.S. Pat. No. 4,739,398 to Thomas, et al., each of which is assigned to the assignee of the present invention and both of which are incorporated herein by reference. Still other suitable techniques are the subject of U.S. Pat. No. 2,662,168 to Scherbatsoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,531 to Kenyon, et al., U.S. Pat. No. 4,230,990 to Lert, et al., U.S. Pat. No. 5,594,934 to Lu, et al., and PCT publication WO91/11062 to Young, et al., all of which are incorporated herein by reference in their entirety.

Other techniques have been developed for measuring media consumption on devices, where the media measurement occurs via a data connection, such as the Internet. Here, the measurement is not taken directly from the audio signal itself, but relies on other data, such as metadata, for determining media exposure. These data measurements may be taken in conjunction with, or in place of, audio-based measurement.

While such systems have shown to be effective at measuring and collecting media research data and correlating it to panelist data, there is considerable concern that the media research data and panelist data is not optimized for privacy. While conventional techniques such as cryptography may be applied to protect such data, the application of cryptographic hashes and the like have shown to be cumbersome in audience measurement systems. Moreover, the processing power required for managing hashes and/or certificates may exceed the capabilities of many portable devices. Accordingly, there is a need in the art to simplify the process by which panelist data is protected from identification.

### SUMMARY

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, audio/video, text, images, animations, databases, broadcasts, displays (including but not limited to video displays, posters and billboards), signs, signals, web pages, print media and streaming media data.

The term “research data” as used herein means data comprising (1) data concerning usage of media data, (2) data concerning exposure to media data, and/or (3) market research data.

The term “presentation data” as used herein means media data or content other than media data to be presented to a user.

The term “ancillary code” as used herein means data encoded in, added to, combined with or embedded in media data to provide information identifying, describing and/or characterizing the media data, and/or other information useful as research data.

The terms “reading” and “read” as used herein mean a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” and “communicating” and as used herein include both conveying data from a source to a destination, and delivering data to a communications medium, system, channel, network, device, wire, cable, fiber, circuit and/or link to be conveyed to a destination and the term “communication” as used herein means data so conveyed or delivered. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, tangibly-embodied software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

The terms “panelist,” “panel member,” “respondent” and “participant” are interchangeably used herein to refer to a person who is, knowingly or unknowingly, participating in a study to gather information, whether by electronic, survey or other means, about that person's activity.

The term “household” as used herein is to be broadly construed to include family members, a family living at the same residence, a group of persons related or unrelated to one another living at the same residence, and a group of persons (of which the total number of unrelated persons does not exceed a predetermined number) living within a common facility, such as a fraternity house, an apartment or other similar structure or arrangement, as well as such common residence or facility.

The term “activity” as used herein includes, but is not limited to, purchasing conduct, shopping habits, viewing habits, computer usage, Internet usage, exposure to media, personal attitudes, awareness, opinions and beliefs, as well as other forms of activity discussed herein.

The term “research device” as used herein shall mean (1) a portable user device configured or otherwise enabled to gather, store and/or communicate research data, or to cooperate with other devices to gather, store and/or communicate research data, and/or (2) a research data gathering, storing and/or communicating device.

The term “portable user device” or “portable monitoring device” as used herein means an electrical or non-electrical device capable of being carried by or on the person of a user or capable of being disposed on or in, or held by, a physical object (e.g., attaché, purse) capable of being carried by or on the user, and having at least one function of primary benefit to such user, including without limitation, a cellular telephone, “smart” phone, a personal digital assistant (“PDA”), a Blackberry device, a radio, a television, a game system (e.g., a Gameboy™ device), a notebook computer, a laptop/desktop computer, a GPS device, a personal audio device (such as an MP3 player or an iPod™ device), a DVD player, a two-way radio, a personal communications device, a telematics device, a remote control device, a wireless headset, a wristwatch, a portable data storage device (e.g., Thumb™ drive), a camera, a recorder, a keyless entry device, a ring, a comb, a pen, a pencil, a notebook, a wallet, a tool, a flashlight, an implement, a pair of glasses, an article of clothing, a belt, a belt buckle, a fob, an article of jewelry, an ornamental article, a shoe or other foot garment (e.g., sandals), a jacket, and a hat, as well as any devices combining any of the foregoing or their functions.

The present disclosure illustrates systems and methods for enacting a peer-to-peer privacy panel for audience measurement. Under various disclosed embodiments, one or more research devices are equipped with hardware and/or software to participate in audience measurement methodologies. The devices are connected to one or more networks in a peer-to-peer configuration according to a predetermined criteria. By manipulating audience measurement data transmissions among peer nodes in a network, and by utilizing concepts of data obfuscation in certain embodiments, results from a panel survey may be reliably obtained while protecting the privacy of the panelists and households participating in a survey.

### BRIEF DESCRIPTION OF THE DRAWINGS

FIG. 1 is a block diagram illustrating an exemplary system for collecting and distributing audience measurement data;

FIG. 2 is a block diagram illustrating another exemplary configuration for distributing audience measurement data in a peer-to-peer configuration;

FIG. 3 is a block diagram illustrating an exemplary configuration for each device transmitting audience measurement data in a network;

FIG. 4A is a block diagram illustrating an exemplary system and process for distributing audience measurement data while maintaining the privacy of data;

FIG. 4B is a block diagram illustrating another exemplary system and process for distributing audience measurement data while maintaining the privacy of data;

FIG. 4C is yet another exemplary system and process for distributing audience measurement data while maintaining the privacy of data;

FIG. 4D is still another exemplary system and process for distributing audience measurement data while maintaining the privacy of data;

FIG. 5 illustrates yet another embodiment where audience measurement data is split and distributed in a peer-to-peer configuration for additional privacy;

FIG. 6 illustrates another exemplary embodiment utilizing media data and other data usage monitoring suitable for peer-to-peer distribution;

FIG. 6A illustrates an embodiment for media data and other data usage processing for anonymous transmission; and

FIG. 7 illustrates a user system utilizing media data and other data monitoring for transmission to a computer-based network.

### DETAILED DESCRIPTION

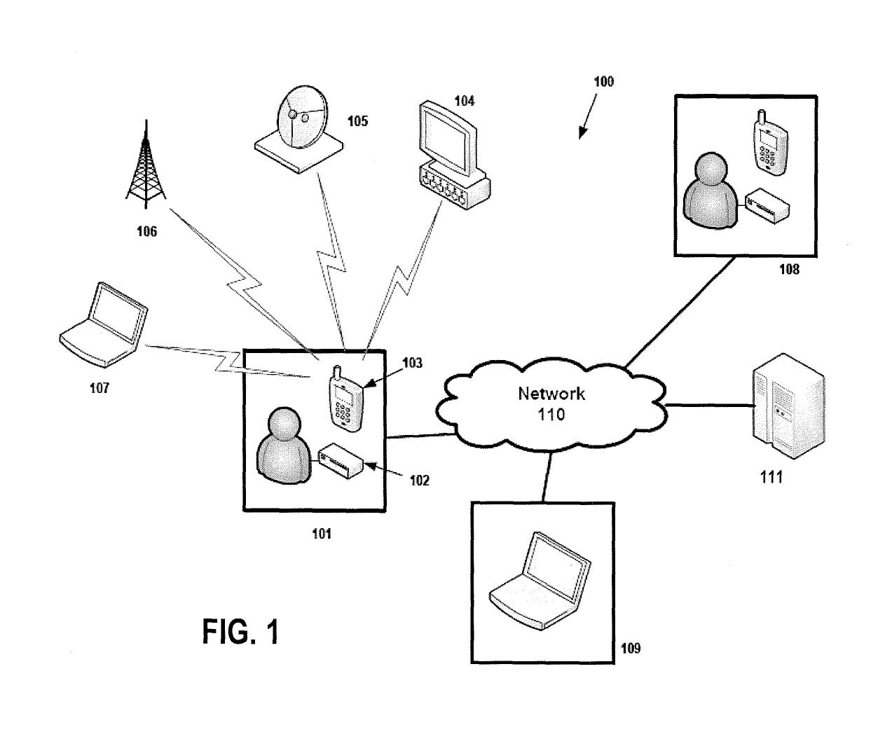

FIG. 1 illustrates an exemplary system (100) for collecting and distributing research data, particularly for audience measurement surveys. System 100 comprises a user system 101 that includes a portable research device 103 that is equipped to receive monitored data that may be transmitted from a multitude of sources including a computer 107, radio transmission 106, satellite transmission 105 or a television 104. The portable research device 103 can comprise either a single device or multiple devices, stationary at a source to be monitored, or multiple devices, stationary at multiple sources to be monitored. Portable research device 103 can also be incorporated in a portable monitoring device that can be carried by an individual to monitor various sources as the individual moves about. Examples include an Arbitron Personal People Meter™, a cell phone, smart phone, tablet, laptop, or any other suitable processing device equipped with appropriate monitoring software.

Where acoustic data including media data, such as audio data, is monitored, the portable research device 103 typically would be an acoustic transducer such as a microphone, having an input which receives media data in the form of acoustic energy and which serves to transduce the acoustic energy to electrical data. Where media data in the form of light energy, such as video data, is monitored, the portable research device 103 takes the form of a light-sensitive device, such as a photodiode, or a video camera. Light energy including media data could be, for example, light emitted by a video display. The portable research device 103 can also take the form of a magnetic pickup for sensing magnetic fields associated with a speaker, a capacitive pickup for sensing electric fields or an antenna for electromagnetic energy. In still other embodiments, the portable research device 103 takes the form of an electrical connection to a monitored device, which may be a television, a radio, a cable converter, a satellite television system, a game playing system, a VCR, a DVD player, a portable player, a computer, a web appliance, or the like. In still further embodiments, the portable research device 103 is embodied in monitoring software running on a computer to gather media data (see, e.g. 109 in FIG. 1).

Various monitoring techniques are suitable. For example, television viewing or radio listening habits, including exposure to commercials therein, are monitored utilizing a variety of techniques. In certain techniques, acoustic energy to which an individual is exposed is monitored to produce data which identifies or characterizes a program, song, station, channel, commercial, etc. that is being watched or listened to by the individual. Where audio media includes ancillary codes that provide such information, suitable decoding techniques are employed to detect the encoded information, such as those disclosed in U.S. Pat. No. 5,450,490 and No. 5,764,763 to Jensen, et al., U.S. Pat. No. 5,579,124 to Aijala, et al., U.S. Pat. Nos. 5,574,962, 5,581,800 and 5,787,334 to Fardeau, et al., U.S. Pat. No. 6,871,180 to Neuhauser, et al., U.S. Pat. No. 6,862,355 to Kolessar, et al., U.S. Pat. No. 6,845,360 to Jensen, et al., U.S. Pat. No. 5,319,735 to Preuss et al., U.S. Pat. No. 5,687,191 to Lee, et al., U.S. Pat. No. 6,175,627 to Petrovich et al., U.S. Pat. No. 5,828,325 to Wolosewicz et al., U.S. Pat. No. 6,154,484 to Lee et al., U.S. Pat. No. 5,945,932 to Smith et al., US 2001/0053190 to Srinivasan, US 2003/0110485 to Lu, et al., U.S. Pat. No. 5,737,025 to Dougherty, et al., US 2004/0170381 to Srinivasan, and WO 06/14362 to Srinivasan, et al., all of which hereby are incorporated by reference herein.

Another category of techniques identified by Walker involves transforming the audio from the time domain to some transform domain, such as a frequency domain, and then encoding by adding data or otherwise modifying the transformed audio. The domain transformation can be carried out by a Fourier, DCT, Hadamard, Wavelet or other transformation, or by digital or analog filtering. Encoding can be achieved by adding a modulated carrier or other data (such as noise, noise-like data or other symbols in the transform domain) or by modifying the transformed audio, such as by notching or altering one or more frequency bands, bins or combinations of bins, or by combining these methods. Still other related techniques modify the frequency distribution of the audio data in the transform domain to encode. Psychoacoustic masking can be employed to render the codes inaudible or to reduce their prominence. Processing to read ancillary codes in audio data encoded by techniques within this category typically involves transforming the encoded audio to the transform domain and detecting the additions or other modifications representing the codes.

A still further category of techniques identified by Walker involves modifying audio data encoded for compression (whether lossy or lossless) or other purpose, such as audio data encoded in an MP3 format or other MPEG audio format, AC-3, DTS, ATRAC, WMA, RealAudio, Ogg Vorbis, APT X100, FLAC, Shorten, Monkey's Audio, or other. Encoding involves modifications to the encoded audio data, such as modifications to coding coefficients and/or to predefined decision thresholds. Processing the audio to read the code is carried out by detecting such modifications using knowledge of predefined audio encoding parameters. It will be appreciated that various known encoding techniques may be employed, either alone or in combination with the above-described techniques. Such known encoding techniques include, but are not limited to FSK, PSK (such as BPSK), amplitude modulation, frequency modulation and phase modulation.

Numerous types of other research operations are possible, including, without limitation, television and radio program audience measurement; exposure to advertising in various media, such as television, radio, print and outdoor advertising, among others; consumer spending habits; consumer shopping habits including the particular retail stores and other locations visited during shopping and recreational activities; travel patterns, such as the particular routes taken between home and work, and other locations; consumer attitudes, awareness and preferences; and so on. For the desired type of media and/or market research operation to be conducted, particular activity of individuals is monitored, or data concerning their attitudes, awareness and/or preferences is gathered. In certain embodiments research data relating to two or more of the foregoing are gathered, while in others only one kind of such data is gathered.

Research data relating to consumer purchasing conduct, consumer product return conduct, exposure of consumers to products and presence and/or proximity to commercial establishments may be gathered, and various techniques for doing so may be employed. Suitable techniques for gathering data concerning presence and/or proximity to commercial establishments are disclosed in US Published Patent Application 2005/0200476 published Sep. 15, 2005 in the names of David Patrick Forr, James M. Jensen, and Eugene L. Flanagan III, filed Mar. 15, 2004, and in US Published Patent Application 2005/0243784 published Nov. 3, 2005 in the names of Joan Fitzgerald, Jack Crystal, Alan Neuhauser, James M. Jensen, David Patrick Forr, and Eugene L. Flanagan III, filed Mar. 29, 2005. Suitable techniques for gathering data concerning exposure of consumers to products are disclosed in US Published Patent Application 2005/0203798 published Sep. 15, 2005 in the names of James M. Jensen and Eugene L. Flanagan III, filed Mar. 15, 2004.

Moreover, techniques involving the active participation of panel members may be used in research operations. For example, surveys may be employed where a panel member is asked questions utilizing the panel member's PUA after recruitment. Thus, it is to be understood that both the exemplary types of research data to be gathered discussed herein and the exemplary manners of gathering research data as discussed herein are illustrative and that other types of research data may be gathered and that other techniques for gathering research data may be employed.

Various portable research devices already have capabilities sufficient to enable the implementation of the desired monitoring technique or techniques to be employed during the research operation. As an example, cellular telephones have microphones which convert acoustic energy into audio data. Various cellular telephones further have processing and storage capability. In certain embodiments, various existing portable research devices are modified merely by software and/or minor hardware changes to carry out a research operation. In certain other embodiments, portable research devices are redesigned and substantially reconstructed for this purpose. In certain embodiments the portable research device may be coupled with a separate research data gathering system and provides operations ancillary or complementary thereto.

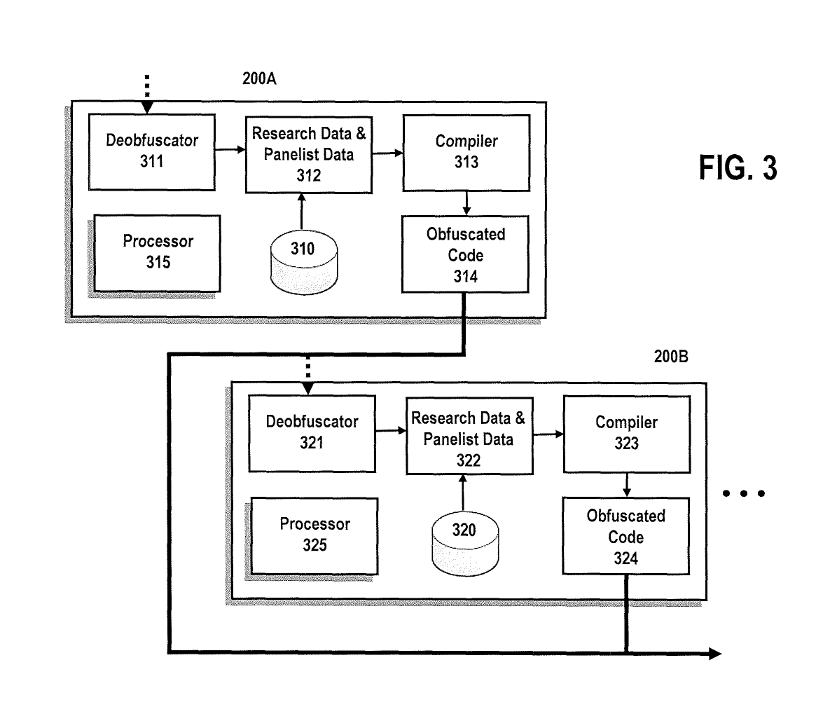

Referring back to FIG. 1, portable research device 103 is equipped with a processor, coupled to a storage device (see FIG. 3) for processing and storing monitored data. In addition, the storage device (see FIG. 3) stores panelist information data that comprises information on the panelist(s) age, sex, income, marital status, panelist demographics, exposure to media, retail store visits, purchases, internet usage, consumer beliefs and opinions relating to consumer products and services, and so on. Additionally, the panelist data may be correlated to household information data that comprises aggregated information on two panelists participating from the same household. Portable research device 103 may also be equipped with, or coupled to, additional devices that provide information on the user's environment, such as a global positioning system (GPS), a thermometer, humidity sensor, etc. Under one embodiment, the portable research device 103 may be coupled to a communications dock 102 for communicating the processed data to a processing facility for use in preparing reports including research data. Each user system (101, 108, 109) is connected to a network 110, which aggregates processed data in one or more servers 111 over time to generate databases useful for panelist and household reports. Under a preferred embodiment, communication dock 102 is not utilized, and device 103 communicates wirelessly via a cellular or other suitable data connection (e.g., WiFi, Bluetooth, etc.).

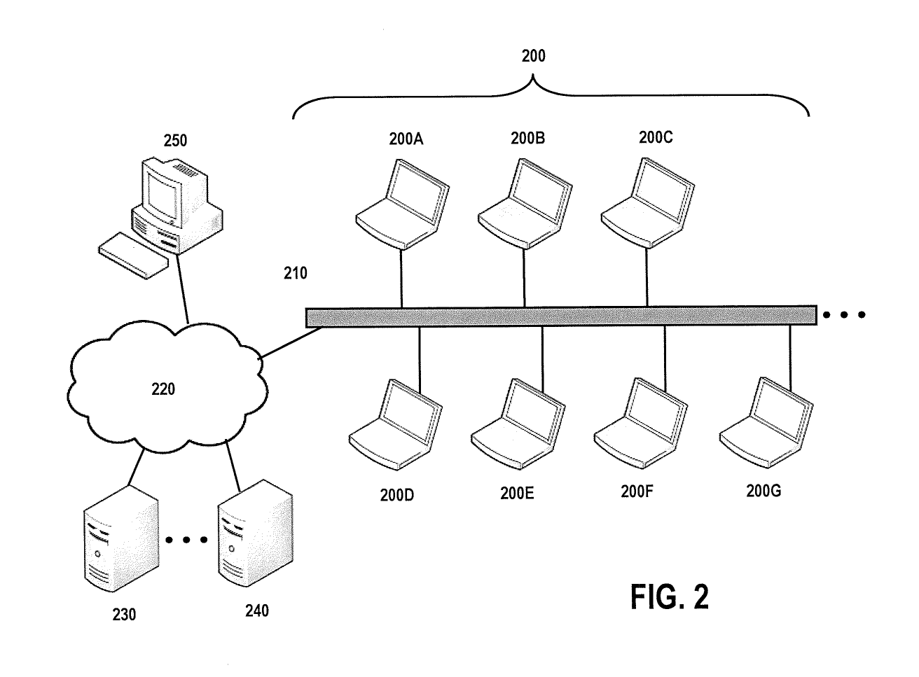

FIG. 2 illustrates an exemplary embodiment where multiple portable devices (200A-200G) are coupled in a peer-to-peer network 200, where each device forms an ad-hoc node in the network. The network topology may be in the form of a bus-type network, as shown in FIG. 2, or may also be a star topology, daisy-chain, or other topologies known in the art. The peer-to-peer network is preferably a sub-network of a main network 220 and may be formed according to predetermined criteria, or in an ad-hoc manner. One or more servers (230-240) would control the formation of the sub-networks, preferably under the direction of a network administrator 250. Additionally, any of servers 230-240 may act as a proxy server between network 200 and other servers for additional privacy. The proxy may be configured as a gateway/tunneling proxy, a forward and/or a backward proxy, depending on the configuration used.

When a network is formed, the portable device nodes are able to utilize resources between one another in order to share data. Under a peer-to-peer network relationship, the nodes (200A-200G) treat each others as equals. In contrast, when a client/server network relationship is formed, one node (server(s) 230-240) handles storing and sharing information and the other nodes (the client) access the stored data. Under a preferred embodiment, the peer-to-peer network 200 is configured using a logical topology to define the way data is passed from endpoint to endpoint throughout the network. Under this embodiment, the logical topology does not give any regard to the way the nodes are physically laid out, but is concerned with getting the data where it is supposed to go.

Under a preferred embodiment, each portable device (200A-200G) is configured in a predetermined manner to establish what data/resources are to be shared and to ensure that resources are made available to the nodes that need to access the data/resources. Also, while each portable device is configured with memory storage (volatile and/or non-volatile), any data to be shared on the network 200 should come from a dedicated area of the memory (e.g., partition), or may come from a separate memory device (e.g., memory card) configured to store and share data during use. This way, the chance of inadvertent sharing would be minimized.

Security for the shared data/resources is the responsibility of the peer that controls them. Each portable device node should implement and maintain security policies for the data/resources and ultimately ensures that only those that are authorized can use the data/'resources. Each peer in a peer-to-peer network is responsible for knowing how to reach another peer, what resources are shared where, and what security policies are in place.

The software required for implementing peer-to-peer sharing is embodied in the form of an application program stored in each portable device (200A-200G). The application program is coupled to database(s) stored in each portable device, and is configured to import demographic and other data for each user of each respective portable device. Software controls may be put into place to allow users to control specific demographic data that is imported, or even prevent some of the data from being used on the peer-to-peer network 200. Once the demographic data is imported, each portable device forwards the data to a central cite (embodied as servers 230-240 in FIG. 2). Under an alternate embodiment, demographic data regarding users of portable devices is pre-loaded into the central site. In any event, the central site would store the data preferably in table form to determine all users of a research operation that are eligible for connection to a peer-to-peer network via a bus 210 or other means known in the art. Alternately, software may be delivered together with content, for example, as a JavaScript or ActiveX code.

Each of the portable devices 200A-200G should preferably possess a unique identification (ID) when a peer-to-peer (P2P) panel is chosen for anonymous networking. Alternately, each of the portable devices 200A-200G may have the same ID for a specific panel that is formed for a particular panel. Under one embodiment, user ID's are selected in accordance with a specialized panel created by a network administrator 250, where each member's ID for the P2P panel relates to the type of research being carried out, instead of the actual identification of the user. Thus, for example, a panel comprising males aged 38 or greater and are identified as being soccer fans may have custom ID's assigned in the format of “P1\S:M\A:>38\Int:SOC_mem01, P1\S:M\A:>38\Int:SOC_mem02 . . . P1\S:M\A:>38\Int:SOC_memX” for each member identified as being suitable for monitoring.

Of course, other configurations are possible where the unique user ID's described above are not used. As an example, a network could be built based on known IP addresses. Also, panelist software can interact with dedicated P2P networks to get connected. Panelist data information could be collected and transmitted in accordance with P2P networks affiliated with specific demographics. If a package arrives that is from a different demographic group, it is passed on to the next node until he right demographic is reached.

When a P2P network is to be formed, a suitable protocol is selected (e.g., NetBIOS, NBT) to provide portable device name registration and resolution, as well as a connection-oriented communication session service. If less reliable network services are desired (e.g., UDP), a connectionless communication for datagram distribution may be formed as well. Before the portable devices (200-A-200G) start a session on the P2P network, each portable device utilizes the network's name service to register its respective name. It is understood by those skilled in the art that the name service contains additional functions for adding names or group names, delete a name or group name, or find a name on the network. Under a preferred embodiment, the name service protocol is run over a TCP/IP connection to allow the portable devices to establish connections to pass communication between them.

Under one exemplary process, the session service primitives include:

Call—for opening a session to a remote service network name.

Listen—listen for attempts to open a session to a service network name.

Hang Up—close a session.

Send—sends a packet to the portable device on the other end of a session.

Send No ACK—like Send, but doesn't require an acknowledgment.

Receive—wait for a packet to arrive from a Send on the other end of a session.

To establish a session under one embodiment, an “Open request” is sent to the portable devices, which is responded to by an “Open acknowledgment.” Next, a “Session Request” packet is sent, which will prompt either a “Session Accept” or “Session Reject” packet. Data is transmitted during an established session by data packets which are responded to with either acknowledgment packets (ACK) or negative acknowledgment packets (NACK). Under a preferred embodiment, NACK packets will prompt retransmission of the data packet. Sessions are closed by sending a close request, where the participating portable devices reply with a close response which prompts the final session closed packet.

Under another embodiment, a “session mode” may be utilized in the network to allow portable devices to establish a connection and provides error detection and recovery. Sessions may be established by exchanging packets, where a TCP connection (port 139) is attempted for the portable devices. If the connection is made, a “Session Request” packet is sent with the names of the application establishing the session and name to which the session is to be established. The portable devices with which the session is to be established will respond with a “Positive Session Response” indicating that a session can be established or a “Negative Session Response” indicating that no session can be established (either because the portable device isn't listening for sessions being established to that name or because no resources are available to establish a session to that name). Once the session is established, data is transmitted by Session Message packets. TCP handles flow control and retransmission of all session service packets, and the dividing of the data stream over which the packets are transmitted into IP datagrams small enough to fit in link-layer packets. Sessions are terminated by closing the TCP connection.

Portable devices 200A-200G are preferably equipped with software allowing for data obfuscation for data being communicated among the portable devices. FIG. 3 illustrates an exemplary embodiment for two portable devices (200A, 200B) that are part of a P2P network, such as the one described above in FIG. 2. It should be understood that other network configurations, which may be different from the one disclosed in FIG. 2, are contemplated in the present disclosure. Each portable device comprises a processor (315, 325) and memory (310, 320) for gathering research data and/or presentation data pursuant to a research operation. In addition, panelist and/or household information is stored in each device.

Each portable device is equipped with obfuscator software for securing panelist information. An obfuscator may generally be described as an algorithm O, such that for any data D, a resultant data O(D) is transformed, such that O(D) is functionally identical to data D, but is much more difficult for others (i.e., non-intended recipients) to understand. In other words, an obfuscator provides a virtual black box in the sense that communicating O(D) to a recipient is equivalent to providing him/her a black box that computes D. The obfuscation process keeps the program's semantic, but makes the program difficult to decompile. Under a preferred embodiment, the obfuscator is embodied as a JAVA-based obfuscator (e.g., KAVA™, ProGuard™, JAVAGuard™), and may be based on any of a number of obfuscation types, including, but not limited to:
(1) Lexical Obfuscation—modifies the lexical structure of a program, typically by splitting identifiers. Under lexical obfuscation, meaningful symbolic information of a JAVA program, such as classes, fields, and method names are replaces with meaningless information (e.g. Crema obfuscation).
(2) Data Obfuscation—modifies the program fields, such as replacing an integer variable in a program with two integers. Data aggregation obfuscations may be used to alter how data is grouped together, such as converting a 2-dimensional array into a one-dimensional array and vice versa. Data ordering obfuscation is another optional technique that changes how data is ordered. For example, an array used to store a list of integers usually has the ith element in the list at position i in the array; instead, a function f(i) may be used to determine the position of the ith element in the list.
(3) Control Obfuscation—obfuscates the control flow in individual program functions. For example, by using opaque predicates, conditional instructions may be communicated whose predicates always evaluate true or false. By branching the instruction based on the evaluation, one branch may be configured to contain meaningful code, while the other branch is configured to contain arbitrary code.
(4) Layout obfuscation—obscures the logic inherent in splitting a program into procedures. One approach is to perform in-line expansion of a procedure in all places where the procedure is called.
   Additional information regarding obfuscation may be found in Collberg et al., “A Taxonomy of Obfuscating Transformations”, Technical Report No. 148, Department of Computer Science, The University of Auckland (1997), as well as Hongying Lai, “A Comparative Survey of JAVA Obfuscatiors”, 415.780 Project Report, Department of Computer Science, The University of Auckland (Feb. 22, 2001). Both of these references are incorporated by reference in their entirety herein.

In certain cases, there may be a desire to protect panelist data as it is being communicated across network 200. In this example, the panelist data could accompany the custom, anonymous ID's described above in connection with FIG. 2, together with research data. By using a substitution cipher (i.e., lexical obfuscation), the panelist data could be obfuscated from unauthorized viewers. A simplified code for an exemplary substitution cipher is provided below

```
create or replace package obfs
is
  function obfs( varchar2 in ) return varchar2;
  pragma restrict_references( obfs, WNPS, WNDS );
  function unobfs( varchar2 in ) return varchar2;
  pragma restrict_references( unobfs, WNPS, WNDS );
end;
/
create or replace package body obfs
is
  xlate_from varchar2(62) :=
    ‘0123456789ABCDEFGHIJKLMNOPQRSTUVWXYZabcdefghijklmnopqrstuvwxyz’;
  xlate_to varchar2(62) :=
    ‘nopqrstuvwxyz0123456789ABCDEFGHIJKLMNOPQRSTUVWXYZabcdefghijklm’;
  function obfs ( clear_text_in varchar2 ) return varchar2
  is
  begin
    return translate( clear_text_in, xlate_from, xlate_to );
  end;
  function unobfs ( obfs_text_in varchar2 ) return varchar2
  is
  begin
    return translate( obfs_text_in, xlate_to, xlate_from );
  end;
end;
/
```

In this exemplary algorithm, panelist data, such as a panelists name, would be obfuscated in order to protect the panelist's privacy. Thus

P1\S:M\A:>38\Int:SOC_mem01_JohnDoe

would become

P1\S:M\A:>38\Int:SOC_mem01_{—}6bUa0bR

The obfuscation may be run in multiple iterations to increase the protection provided for the data. Text may also be broken into segments and rearranged in addition to the obfuscation. Additional techniques for obfuscating panelist, and other, data are possible and should be apparent to one skilled in the art.

Referring back to exemplary embodiment of FIG. 3, research data and/or panelist data (312, 32) is communicated to a compiler (313, 323) that produces obfuscated code (314, 324). Using a JAVA embodiment, the JAVA source code is complied into the byte code, where the byte code is interpreted and executed by a JAVA Virtual Machine (JVM). In this case, the byte code would be hardware independent, and is preferred under the present embodiment. Deobfuscators (311, 321), also known in the art as “decompilers” are present on the portable devices to process and interpret obfuscated code as required. In the configuration illustrated in FIG. 3, each device has the capability to deobfuscate at least a portion of the obfuscated code to determine communication pathways, particularly when control obfuscation is being utilized. Additional data for other obfuscation techniques may also be decompiled, depending on the configuration desired for a specific P2P network, and the desired level of security. While the deobfuscators (311, 321) are illustrated as being resident on the portable devices, it is also possible to provide a single deobfuscator on a central server (230, 240), where deobfuscation could be carried out exclusively, or in conjunction with deobfuscation performed on the portable device level.

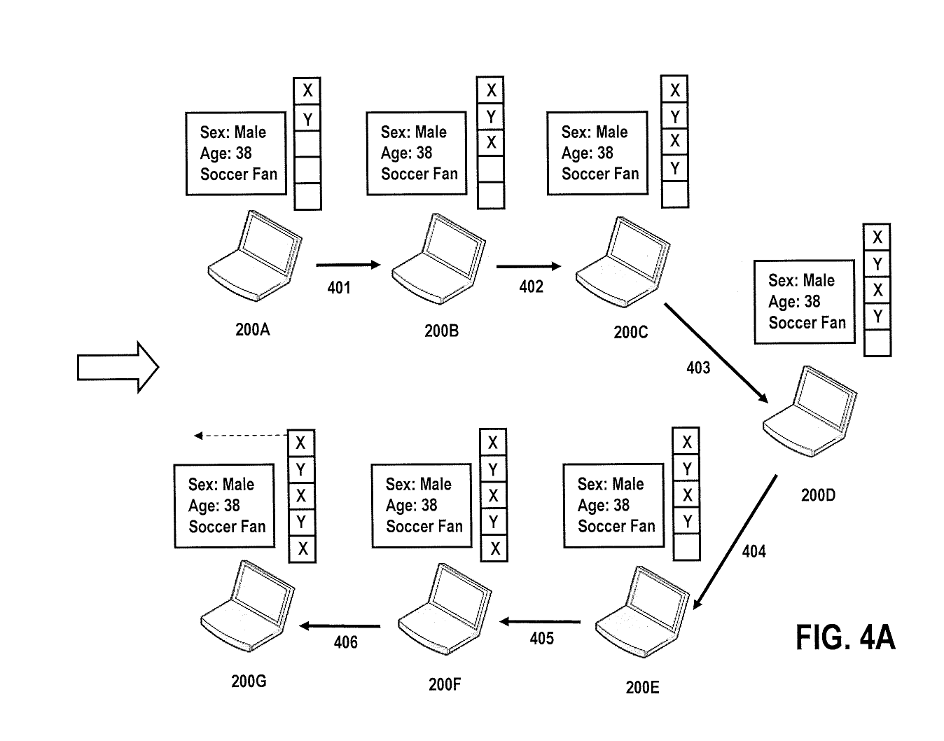

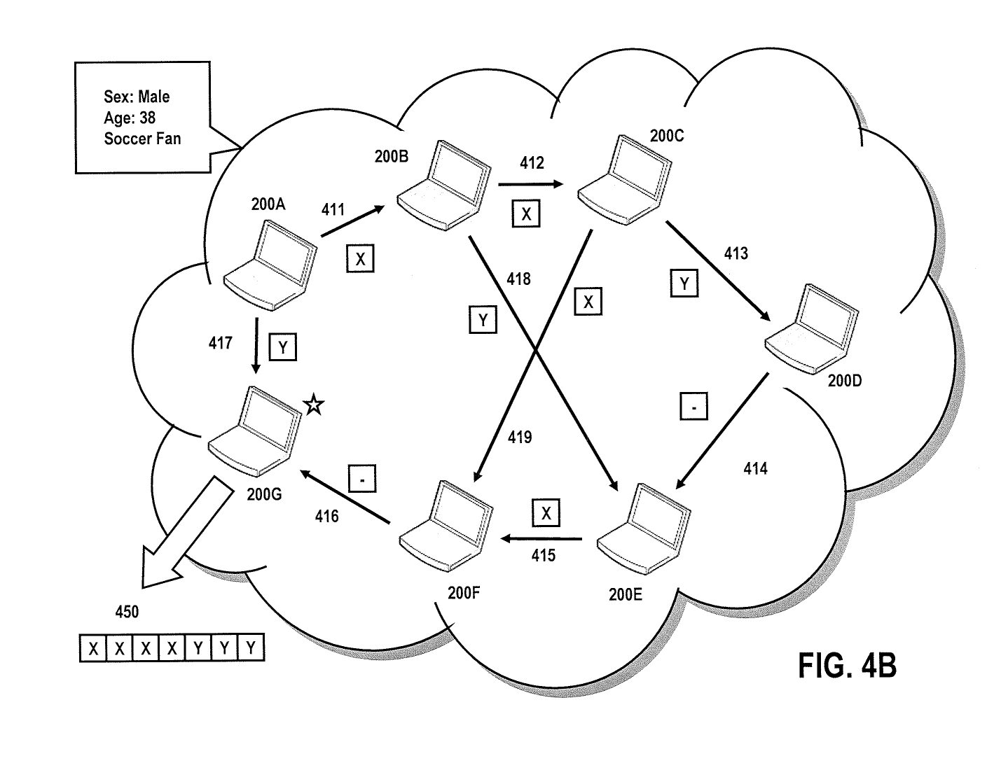

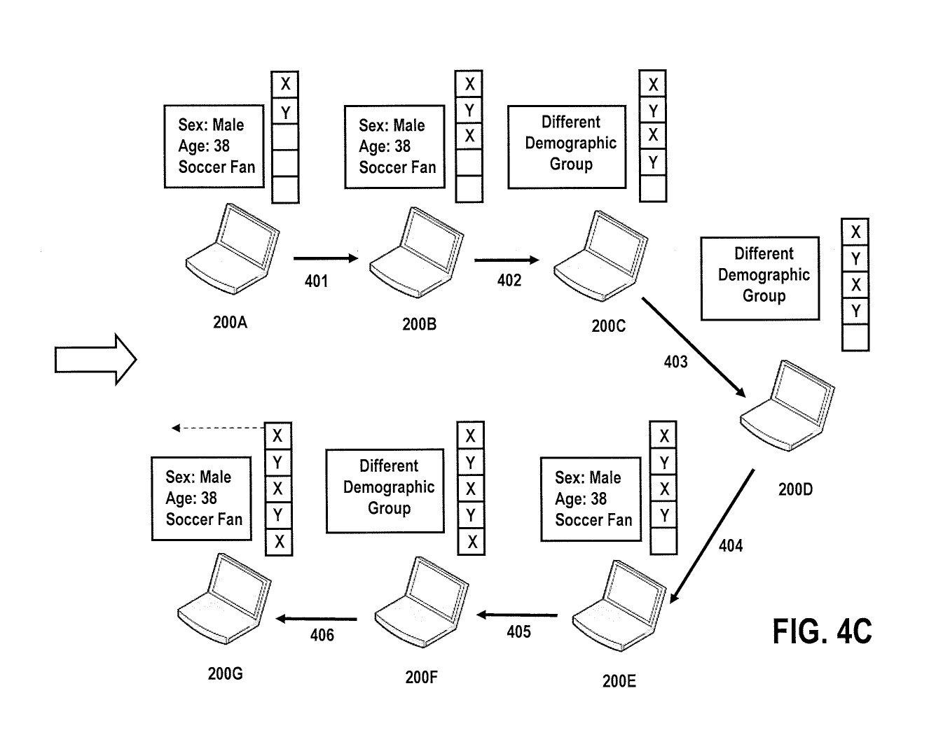

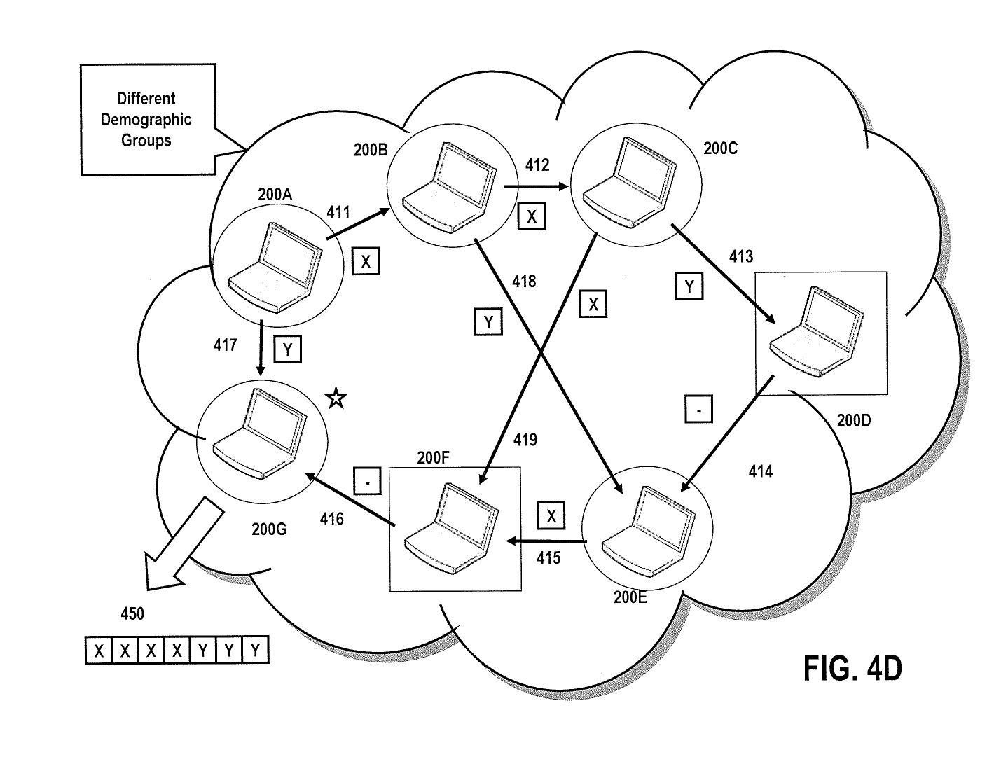

FIG. 4 illustrates an exemplary embodiment where each of a plurality of portable user devices (200A-200G) are participating in a research operation, where a demographic P2P network is formed using the techniques described above. In the example, males aged 38, that are listed as being soccer fans, are connected together to a sub-network and are configured to serially pass research data from one node (e.g., 200A) to the next (e.g., 200B). When a session is started, each of the portable devices record, and make available for the P2P network, research data which may be based on radio, television, streaming media, or other content. Each of the portable devices in FIG. 4 may receive media content in physically disparate locations, or receive media content in a localized venue (i.e., concert stadium, campus hall, etc.).

When content 410 is broadcast and/or transmitted, each of the portable devices (200A-200G) selected for the P2P network may, or may not, be configured to receive the content. In the example of FIG. 4, device 200A receives and records research data indication that content identified as “X” and “Y” were viewed. After undergoing an obfuscation process, information regarding the research data from device 200A is communicated 401 to device 200B, which has recoded that media exposure was present for content “X” (but not “Y”). After performing any necessary deobfuscation, device 200B appends the devices research data to the list, performs an obfuscation process, and forwards the list 402 to device 200C, where another deobfuscation process may be performed. Device 200C records its media exposure to content “Y” (but not “X”) and appends the result to the list. After obfuscating the data, the list is forwarded 403 to device 200D

Device 200D in the example has not been exposed to any media content, or at least was not exposed to any media content identified as “X” or “Y”. In this case, portable device 200D may deobfuscate/obfuscate the research data (depending on the obfuscation technique being utilized), or may simply pass-through the research data and communicate it 404 to device 200E. Similar to device 200D, device 200E was not exposed to any identifiable media content. Again, device 200E may deobfuscate/obfuscate the research data or simply communicate 405 the research data to device 200F, which has recorded exposure to media content “X”. Just as before, the content expose is appended, processed and communicated 406 to device 200G, which was not exposed to any identifiable media content, and is also configured as the last node on the P2P-network. After performing any necessary deobfuscation/obfuscation, device 200G forwards the total result to a central site for processing and tabulation.

Unlike conventional systems, the end results of the research operation will not be traceable to any particular user, which is primarily due to the P2P panel and data obfuscation. In the example of FIG. 4A, after receiving the end results, the research operation administrator would formulate data indicating that, for male soccer fans aged 38, 3 members of a P2P panel were exposed to content “X”, and 2 members of the P2P panel were exposed to content “Y”. Additionally, since the number of connected P2P nodes should be known prior to the start of a session, the research data may easily be expressed as a percentage of participants for a particular demographic panel, i.e., 42% of panelists (3 out of 7) were exposed to content “X” and 29% of panelists (2 out of 7) were exposed to content “Y”.

It should be understood that the configuration and data flow described in FIG. 4A is merely one example, and that a multitude of other configurations are possible under the present disclosure. One such configuration is illustrated in FIG. 4B, where, just as in FIG. 4A, a P2P network is formed for a number of devices (200A-200G) for a particular demographic. However, in FIG. 4B, the distribution of research data (as well as panelist data) is not performed serially, but instead is distributed throughout the network using control or layout obfuscation. When a session is established, portable devices within the network may be given nodal assignments to establish control flow for research data formed in each device. Also, under a preferred embodiment, one of the nodes (designated with a star in FIG. 4B) should be designated as a research data aggregator, where all of the research data for the P2P session is forwarded prior to being communicated to a central site. Under an alternate embodiment, each of the portable devices (200A-200G) may transmit their collected research data individually to the central site.

In the embodiment of FIG. 4B, device 200A is exposed to media content “X” and “Y”, where one portion of the research data is communicated 411 to device 200B and another portion is communicated 417 to device 200G. Device 200B is also exposed to media content “X” and “Y”, and one portion is communicated 412 to device 200C and another portion is communicated 418 to device 200E. Device 200C is exposed to media content “X” and “Y” as well, where one portion is communicated 419 to device 200F and another portion is communicated 413 to device 200D. Device 200D is not exposed to any identifiable media content in the example. Device 200E is exposed to media content “X” that is communicated 415 to device 200F, which is not exposed to any identifiable media content.

In the exemplary embodiment of FIG. 4B, the flow of exposure data may take any number of configurations. Under one embodiment, each portable device only forwards individually obfuscated exposure data to another device, where, at a predetermined time for the session, each portable device pushes the stored exposure data to a single device (e.g., portable device 200G) for communication to the central site. The stored exposure data should preferably not be the exposure data for the device itself, but instead be the exposure data communicated from one or more other device in the network. This way, user identification, as it relates to the exposure data, is further protected. In another exemplary embodiment, it is possible, by using one or a combination of obfuscation techniques to include the user's data as well. In yet another exemplary embodiment, each device can aggregate and/or append exposure data locally, and communicate the entire string to another device.

When exposure data for the session in FIG. 4B is concluded, a research data aggregator node (450) forwards the collected research data to the central site for further processing. As can be see from the figure, the results of the particular research session indicates that, for the specified demographic P2P network, 4 devices were exposed to media content “X” and 3 devices were exposed to media content “Y”. As stated above, while the results of the research session are known, the identities of the research panelists/participants are not.

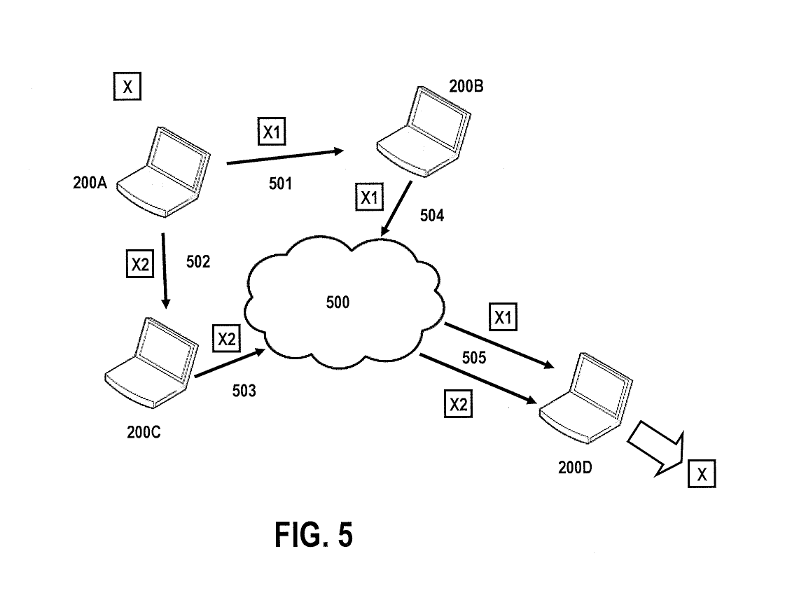

Turning to FIG. 5, another exemplary embodiment is illustrated, where the research data itself is obfuscated utilizing a splitting technique for the research data. Under this technique, the data is parsed to determine all software tokens for the data, and all variables for the data are searched. Specific variables are then chosen for obfuscation, where the variables may be extended or split when undergoing an obfuscation transformation. When utilizing a splitting technique, a number of different approaches may be used: (1) utilizing a “parse tree”, where a long term variable is split into short-term variables using an arithmetic function, (2) using permutation order lists, where specific data may be expressed as permutations, and the obfuscation parameters can be used to control the size of the data elements, where a mapping function is performed to reassemble the permutation (e.g., used ID 123456 may be permutated into {123} {456}, and further into {12} {34} {56}); (3) using a module method, (4) using boolean operators to split variables (e.g., NOT, XOR, AND, etc.), or (5) restructuring arrays, where a specific array may be split into several sub-arrays, merge two or more arrays into one array, fold an array to increase the number of dimensions, or flatten an array to decrease the number of dimensions.

In FIG. 5, an exemplary embodiment is shown where the research data for portable device 200A indicates that the device was exposed to media content “X”. When an obfuscation function is performed on the research data (“X”), the data is permutated into two separate portions: “X1” and “X2”. Each of these portions are then transmitted separately (501, 502) to different nodes (200C, 200B), where each node, in turn, forwards the portions (503, 504) to other nodes in P2P network 500. Depending on the routing chosen for each node's portions, both portions may subsequently be forwarded 505 to an aggregating node 200D. Alternately, each portion may be separately transmitted from separate nodes to a central site, where mapping may be performed to reassemble the research data permutations. Also, as discussed above with reference to FIGS. 4A and 4B, each portable device may append its own (and/or other) research data portions to the received portions at the node before transmitting to other nodes/locations.

Under another exemplary embodiment, the systems described above may be implemented on a decentralized network such using anonymous P2P protocols (see, http://anonymous-p2p.org/), MUTE (see, http://mute-net.sourceforge.net/), Freenet (see, http://freenetproject.org/), Anonymous Routing with Hierarchical Rings (ARHR), Onion Routing, CliqueNet, or any other suitable architecture. The architecture should be arranged so that it becomes difficult—if not impossible—to determine whether a node that sends a message originated the message or is simply forwarding it on behalf of another node. Under such a configuration, every node in an anonymous P2P network acts as a universal sender and universal receiver to maintain anonymity.

Under one embodiment, each user runs a network that provides the network with storage space. When research data is added to the network (as one or more files), the user's device sends to the network an insert message containing the research data along with an assigned location-independent globally unique identifier (GUID), which causes the file to be stored on some set of nodes. During a research operation, research data for each user may migrate or be replicated on other nodes. To retrieve one or more files, a request message is transmitted containing a GUID key. When the request reaches one of the nodes where the file is stored, that node passes the data to the requestor. The GUID keys may be calculated using SHA-1 secure hashes, where the network utilizes content-hash keys and signed-subspace keys for keeping users and data anonymous.

Under one embodiment, the GUID used to identify a node in a P2P network is temporary. After messages pass from one node to the next, the GUID may be configured to change in order to render the message untraceable. With new GUID's being generated, the P2P network operates so that, if a neighboring node is hacked in the network, the sending node will not be identifiable.

Referring back to FIG. 4C, the embodiment corresponds substantially to the embodiment of FIG. 4A, except that users of certain devices (200C, 200D, 200F) are affiliated with different demographic groups in a P2P network. Utilizing the techniques described above, information from targeted users (e.g., male, 38, soccer fan) are passed anonymously through nodes of other demographic groups. Preferably, an application layer decides if a node corresponds to a targeted group and whether user information should be added. Similarly, FIG. 4D. which corresponds substantially to the embodiment of FIG. 4B, illustrates the passing of data of different demographic groups (designated by the circle and square outline).

The content-hash keys (CHK) are the low-level data storage keys and are generated by hashing the contents of the file to be stored. This process gives every file a unique absolute identifier that can be verified quickly. Preferably, each CHK reference will point to one file or one user's research data. CHKs also permit identical copies of a file inserted by different people to be automatically joined, since the same key may be used for each file or research data. Signed-subspace keys (SSK) provide a personal namespace that any member of the network may read, but only its owner can write to. For example, for a specific research operation, a subspace may be created and a random public-private key pair is generated to identify it. Research data files would then be created (e.g., “Arbitronpanel1/StationXYZ/Show123”) and the file's SSK would be calculated by hashing the public half of the subspace key and the descriptive string independently before concatenating them and hashing again.

To retrieve a file from a subspace, the subspace's public key would be used and the descriptive string, from which the SSK could be recreated. SSKs may be used to store indirect files containing pointers to CHKs rather than to store data files directly. Indirect files can also be used to split large files into multiple portions by inserting each portion under a separate CHK and creating an indirect file that points to all the portions. Indirect files may also be used to create hierarchical namespaces from directory files that point to other files and directories pertaining to research operations. SSKs can also be used to implement an alternative domain name system for nodes that change address frequently. Each such node would have its own subspace, and could be contacted by looking up its public key (address resolution key) to retrieve the current address.

Because each node in the chain knows only about its immediate neighbors, the end points could be anywhere among the network's hundreds of thousands of nodes, which are continually exchanging indecipherable messages. Not even the node immediately after the sender can tell whether its predecessor was the message's originator or was merely forwarding a message from another node. Similarly, the node immediately before the receiver can't tell whether its successor is the true recipient or will continue to forward it.

Continuing with the embodiment, every node preferably maintains a routing table that lists the addresses of other nodes and the GUID keys it thinks they hold. When a node receives a query, it first checks its own store, and if it finds the file, returns it with a tag identifying itself as the data holder. Otherwise, the node forwards the request to the node in its table with the closest key to the one requested. That node then checks its store, and so on. If the request is successful, each node in the chain passes the file back upstream and creates a new entry in its routing table associating the data holder with the requested key. Depending on its distance from the holder, each node might also cache a copy locally. The GUID and routing tables may be dynamic and change randomly or change according to a predetermined event/trigger or command.

To conceal the identity of the data holder, nodes may occasionally alter reply messages, setting the holder tags to point to themselves before passing them back up the chain. Later requests will still locate the data because the node retains the true data holder's identity in its own routing table and forwards queries to the correct holder. Routing tables are not revealed to other nodes. To limit resource usage, the requester gives each query a time-to-live (TTL) limit that is decremented at each node. If the TTL expires, the query fails, although the user can try again with a higher TTL, up to some maximum.

If a node sends a query to a recipient that is already in the chain, the message is bounced back and the node tries to use the next-closest key instead. If a node runs out of candidates to try, it reports failure back to its predecessor in the chain, which then tries its second choice, and so on.

With this approach, requests home in closer with each hop until a key is found. Each subsequent query for this key will tend to approach the first request's path, and a locally cached copy can satisfy the query after the two paths converge. Subsequent queries for similar keys will also jump over intermediate nodes to one that has previously supplied similar data. Nodes that reliably answer queries will be added to more routing tables, and hence, will be contacted more often than nodes that do not.

To insert a file during a research operation, a user's device assigns the file a GUID key and sends an insert message to the user's own node containing the new key with a TTL value that represents the number of copies to store. Upon receiving an insert, a node checks its data store to see if the key already exists. If so, the insert fails—either because the file is already in the network (for CHKs) or the user has already inserted another file with the same description (for SSKs). In the latter case, the device chooses a different description or perform an update rather than an insert. As mentioned above, the GUID can be static or dynamic.

If the key does not already exist in the node's data store, the node looks up the closest key and forwards the message to the corresponding node as it would for a query. If the TTL expires without collision, the final node returns an “all clear” message. The device then sends the data down the path established by the initial insert message. Each node along the path verifies the data against its GUID, stores it, and creates a routing table entry that lists the data holder as the final node in this chain. As with requests, if the insert encounters a loop or a dead end, it backtracks to the second-nearest key, then the third-nearest, and so on, until it succeeds.

Under another exemplary embodiment, IP addresses of nodes in a P2P network (see, e.g., FIG. 2, and FIG. 4A-5) may be replaced with hashes, where a node (peer) knows only the hashes of the other peers, but not necessarily the IP addresses. Thus, each node in a network has an overlay address that is derived from its public key. The overlay address functions as a pseudonym for the node, allowing messages to be addressed to it.

Under this embodiment, only the addresses of neighboring nodes are preferably known in order to route TCP/IP traffic and in order to avoid direct node connections. Sometimes referred to as “ant-inspired” routing, node hashes may serve as a “virtual” address, where each node in the network has a virtual address that may be generated randomly each time it starts up. Since neighbors in the network do not know each other's virtual addresses, it becomes difficult, if not impossible to determine the identity of the user connected to the node.

By utilizing the techniques described herein, nodes within a P2P network will only be exposed to research data, without easily having the ability to trace back received information. Additionally, the information for groups of panelists will be protected, where only the demographic makeup of a panel will be known. The executable code for the embodiments described above may installed on portable device's chips, firmware, or other software application, the operating systems of portable devices, or embedded in browsers, toolbars, media players or plug-ins. Additionally, the executable code may be embedded in applications, applets, widgets, or even appended to content that is downloaded from a network.

It should be appreciated by those skilled in the art that the embodiments discussed herein for communicating media exposure data in a P2P network is applicable to a wide variety of data formats. In addition to audio codes and audio-related data, the media exposure data may include other data as well. For example, data relating to the media data may include a “cookie”, also known as an HTTP cookie, which can provide state information (memory of previous events) from a user's browser and return the state information to a collecting site, which may be the content source 125 or collection site 121 (or both). The state information can be used for identification of a user session, authentication, user's preferences, shopping cart contents, or anything else that can be accomplished through storing text data on the user's computer. When setting a cookie, transfer of content such as Web pages follows the HyperText Transfer Protocol (HTTP). Regardless of cookies, browsers request a page from web servers by sending a HTTP request. The server replies by sending the requested page preceded by a similar packet of text, called “HTTP response.” This packet may contain lines requesting the browser to store cookies. The server sends lines of Set-Cookie only if the server wishes the browser to store cookies. Set-Cookie is a directive for the browser to store the cookie and send it back in future requests to the server (subject to expiration time or other cookie attributes), if the browser supports cookies and cookies are enabled. The value of a cookie can be modified by sending a new Set-Cookie: name=newvalue line in response of a page request. The browser then replaces the old value with the new one. Cookies can also be set by JavaScript or similar scripts running within the browser. In JavaScript, the object document.cookie is used for this purpose.

Various cookie attributes can be used: a cookie domain, a path, expiration time or maximum age, “secure” flag and “HTTPOnly” flag. Cookie attributes may be used by browsers to determine when to delete a cookie, block a cookie or whether to send a cookie (name-value pair) to the collection site 121 or content site 125. With regard to specific “cookies”, a session cookie may be used, which typically only lasts for the duration of users using the website. A web browser normally deletes session cookies when it quits. A session cookie is created when no expires directive is provided when the cookie is created. In another embodiment, a persistent cookie (or “tracking cookie”, “in-memory cookie”) may be used, which may outlast user sessions. If a persistent cookie has its Max-Age set to 1 year, then, within the year, the initial value set in that cookie would be sent back to a server every time a user visited that server. This could be used to record information such as how the user initially came to the website. Also, a secure cookie may be used when a browser is visiting a server via HTTPS, ensuring that the cookie is always encrypted when transmitting from client to server. An HTTPOnly may also be used. On a supported browser, an HTTPOnly session cookie may be used for communicating HTTP (or HTTPS) requests, thus restricting access from other, non-HTTP APIs (such as JavaScript). This feature may be advantageously applied to session-management cookies.

Various types of media exposure data and research data may also be collected into reports, where these reports may include audio codes, audio signatures, Internet usage and the like. For audio signatures, the processing device can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO/2002/11123 to Wang, et al. and PCT publication WO/2003/091990 to Wang, et al., all of which are incorporated herein by reference in their entireties. The signature extraction may serve to identify and determine media exposure for the user of a device. Audio signatures may be taken from the frequency domain, the time domain, or a combination of both.

Media exposure data may also include monitoring of device software usage and/or access, sometimes referred to as “app data.” Examples of such monitoring is described in U.S. patent application Ser. No. 13/001,492, titled “Mobile Terminal And Method For Providing Life Observations And A Related Server Arrangement And Method With Data Analysis, Distribution And Terminal Guiding” filed Mar. 9, 2009, U.S. patent application Ser. No. 13/002,205, titled “System And Method For Behavioural And Contextual Data Analytics,” filed Mar. 8, 2009, and Int'l Pat. Pub. No. WO 2011/161303 titled “Network Server Arrangement For Processing Non-Parametric, Multi-Dimensional Spatial And Temporal Human Behavior Or Technical Observations Measured Pervasively, And Related Method For The Same,” filed Jun. 24, 2010. Each of these documents is incorporated by reference in their entireties herein.

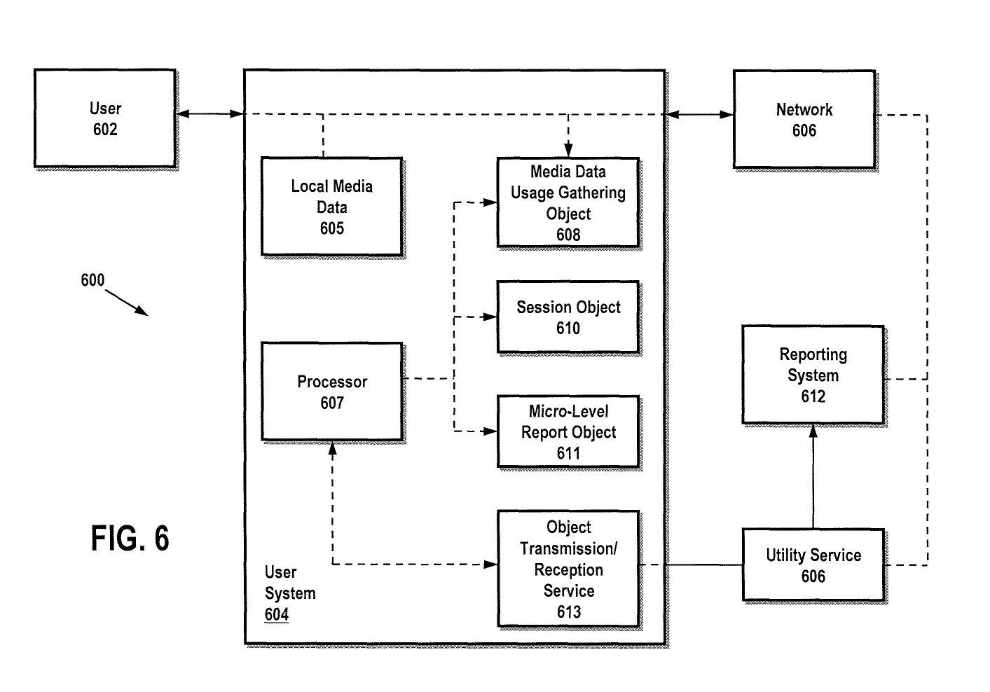

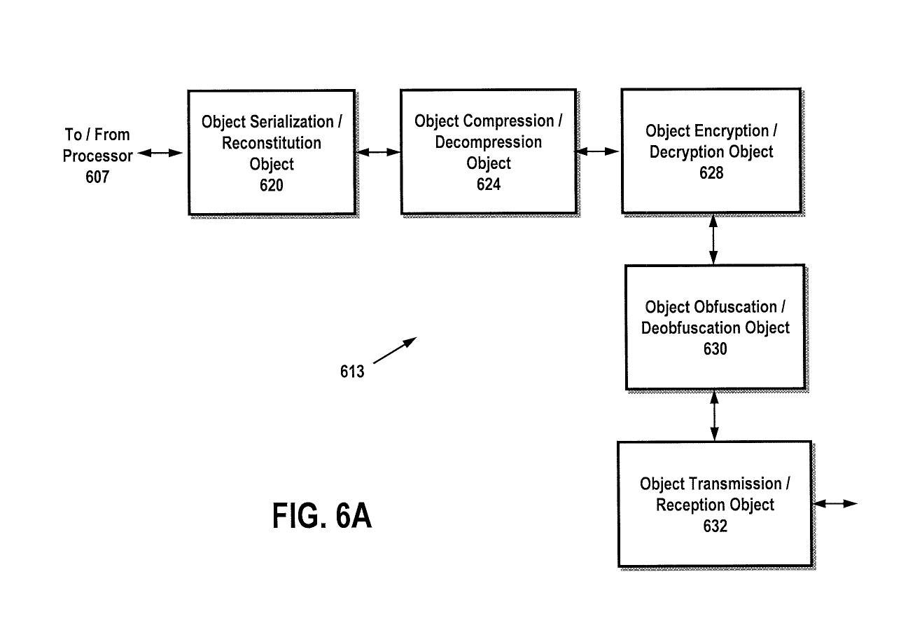

FIG. 6 illustrates a media data usage system 600 in which a user 602 is presented with media data by means of a user system 604. The user system 604 is coupled with a network 606 in order to access media data and/or present media data to the user 602. Network 606 may also include P2P networks that communicate with utility service 606 and/or reporting system 612, described below. User system 604 incorporates a local source of media data 605 from which the user system 604 also obtains media data for presentation to the user 602. The local source 605 may be, for example, a hard drive or other storage device or devices which store prerecorded media data and/or media data downloaded via network 606 and stored in local source 605 for later presentation to user 602. The user system may also serve to obtain a combination of media data both via network 606 and from local source 605 for simultaneous presentation to user 602 or combined in a stream of audio and/or video media data. The user system 604 is coupled with the network 606 in any available manner, including but not limited to over-the-air (wireless), cable, satellite, PSTN (Public Switched Telephone Network), DSL (Direct Subscriber Line), LAN (Local Area Network), WAN (Wide Area Network), intranet, and/or the Internet.

User system 604 incorporates a media usage monitoring processor 607 which implements a media data usage monitoring service within the user system 604. However, unlike previously proposed techniques the processor 607 not only gathers data representing usage of media data by means of the system 604, but also processes the gathered data to produce micro-level report objects for use by a reporting system in producing reports concerning usage of media data. Essentially, the processor 607 carries out its tasks by managing media data usage gathering objects 608 which serve to gather the usage data initially, session objects 610 which merge the objects 608 into user sessions and/or resource control location (RCL) sessions and micro-level report objects 611 which merge the session objects and/or other data gathering objects for reporting purposes.

In certain embodiments, the processor 607 is implemented by a dedicated device as a peripheral of the user system 604 or as a board or other device inserted within the user system 604 or otherwise coupled therewith. In certain implementations of these embodiments, the device is a programmable device provided with pre-stored instructions to implement processor 607. In other implementations, software for the processor 607 is downloaded to the device via the network 606 or other communication medium or loaded therein from a storage medium. In other embodiments the processor 607 is implemented in software running on the user system, and loaded therein from the network 606 or other communication medium, or from a storage medium. In certain embodiments processor 607 is dedicated to monitoring usage by only a single user. In other embodiments, the processor 607 monitors usage by two or more users of the user system 604.

Processor 607 instantiates the media data usage gathering object 608 which runs within the processor 607 or elsewhere in user system 604 for gathering usage data representing usage of media data by the user. Object 608 serves to gather usage data for a single predetermined category of media data, such as graphical data, audio data, streaming media data, video data, text, web pages, image data, and the like. In this manner, object 608 preprocesses usage data by selecting the data based upon predetermined criteria. In certain embodiments, each object 608 is dedicated to monitoring usage of media data of only one format, such as JPEG image data, AVI data, streaming media data to be reproduced by a certain player type, HTML, documents, BMP image data, etc. Media format may also include one or more techniques used to collect audio codes and/or audio signatures. In certain embodiments, each object 608 is dedicated to monitoring usage of media data presented by means of only one type of user agent, such as a particular browser, player, etc. As new or different data formats and user agents become available, new or different objects 608 and/or object classes are provided to the processor 607 to enable monitoring thereof. The objects and object classes are received by the processor 607 via network 606 or other communication medium, or else from a storage medium. The monitoring capabilities are thus updated quickly and efficiently to keep pace with the ongoing, rapid evolution of media data formats and user agents.

In certain embodiments, data gathered by object 608 represents media usage events such as the opening or closing of a user agent, a request for or receipt of new or different content or resource control location channel, scrolling, volume change, muting, onclick events, maximizing or minimizing a window, accessing software or apps, an interactive response to received content (such as a submission of a form or order), and/or the like. In other embodiments, object 608 polls for predetermined media data state information, such as currently received content or currently accessed resource control location and/or the state of a user agent. Depending on the embodiment, object 608 records either changes in state and/or the state itself. In further embodiments, object 608 collects content metadata accompanying or associated with the media data. In other embodiments combinations of the foregoing are employed. In certain embodiments the attributes of the object 608 include times or durations of the events or state information.

In certain embodiments object 608 gathers data at the board level (for example, a sound card), while in other embodiments it gathers data at the network level. In still other embodiments it gathers data at the operating system level, while in still further embodiments it gathers data at the application level (for example, a player, viewer or other application). In yet still further embodiments, the object 608 gathers data at two or more of the foregoing levels. Processor 607 instantiates the session object 610 which runs within the processor 607 or elsewhere in user system 604 for merging the media data usage gathering object 608 into a respective session object which gathers data for a respective user session.

In certain embodiments the user session is defined by grouping media data usage gathering objects based on time or duration criteria. In various such embodiments, media data usage gathering objects representing usage (presentation or access) within each of predetermined time periods (such as dayparts or days) are grouped in corresponding user sessions. In other such embodiments, media data usage gathering objects representing one or more continuous and/or overlapping resource control location sessions are grouped in a single user session, while in further such embodiments media data usage gathering objects representing resource control location sessions separated in time by no more than a predetermined period are grouped into a single user session. In still other such embodiments combinations of the foregoing criteria are employed to group the objects into user sessions.

In other embodiments the user session is defined by grouping media data usage gathering objects based on indications of user activity. In various such embodiments, user inputs (for example, by means of a keyboard, keypad, pointing device, dial, remote control or touch screen, or an activity such as the insertion of prerecorded media in a disk drive, tape player or the like) are monitored to detect continuing user activity to determine the duration of a user session. In further embodiments, users are asked to indicate the beginning and/or the end of a user session.

In certain embodiments, one or more of the following attributes are included in the session objects: (1) “Session start”: the time that an RCL is first accessed by the user system and the media data is delivered thereto, or else when such media data is first presented to the user; (2) “Session stop”: the time that the user system ceases to access the RCL, or else when presentation of its media data to the user ceases; (3) “Session duration”: the duration of a user session, which may be measured as the length of time between Session start and Session stop; (4) “Session content”: the type and identity of the presented or accessed media data; (5) “Session interaction”: user interaction events occurring during a user session; (6) “Session content events”: media data events occurring during a user session; (7) “Session context”: system events occurring during a user session; (8) “Session metadata”: data describing the user session and any supporting data.

Processor 607 instantiates the micro-level report object 611 which serves to merge session objects and/or other objects into itself, and/or to encapsulate data, for supply to one or more reporting systems for producing media usage reports. In certain embodiments, the object 611 merges one or more session objects representing the media data usage of a single user into a corresponding micro-level report object, while in others the object 611 merges session objects into a micro-level report object representing media data usage by multiple identified users. In certain embodiments the object 611 merges one or more session objects representing media data usage within a predetermined time span, while in other embodiments object 611 merges session objects in response to a request from a reporting system 612 coupled with user system 604 either through the network 106 or via a different communication medium.

In certain embodiments, media data usage-gathering object 608 provides its data directly to the micro-level report object, rather than merging into a session object. This feature enables the micro-level report object to gather and encapsulate data at levels other than a user session level. One particularly advantageous, but not exclusive, application for this feature is the ability to gather and convey data representing a respective RCL session on a given user system. This capability permits media usage data to be collected, inter alia, for interim reporting. Interim reporting capability is desired for monitoring ongoing usage trends in the case of streaming media of a respective RCL, to enable dynamic streaming adjustments based on real-time user profiles and habits. For example, the choice of an advertisement to insert in the stream can be based on monitoring of such usage trends in this manner.

In certain other embodiments, an RCL session object is provided to merge media data usage gathering objects representing usage within a respective RCL session. The RCL session object either gathers data until merged into a micro-level report object for interim reporting, or else merges media data usage gathering objects representing usage within all or part of a respective RCL session. In certain embodiments, a micro-level report object merges one or more RCL session objects for a given RCL session to provide a report of the RCL session. In certain embodiments, the micro-level report objects 611 are arranged to report media usage data for one or more user sessions and/or RCL sessions in response to selectable parameters including a defined time period, one or more designated RCL's and/or users. In various ones of the embodiments in which media usage data is reported by micro-level report objects 611, the objects 611 are also arranged to gather and/or merge objects which gather quality of service data from the user system, including bandwidth usage, network quality, sound quality and/or video quality for one or more user sessions, RCL and/or RCL sessions. In certain embodiments, object 611 merges session objects and/or other objects, or gathers data, reflecting usage of only a single type of media data, while in other embodiments object 611 merges objects and/or gathers data representing usage of multiple different types of media data. In still further embodiments, various combinations of the foregoing parameters are used by the object 611 to merge the objects and/or gather data.

A bi-directional object transmission/reception service 613 may be implemented by the user system either within processor 607 or external thereto. Service 613 may communicate with a reporting system 612 to receive requests for micro-level report objects and to communicate the requested objects thereto. Service 613 also receives updated objects and object classes from a utility service 614. In certain embodiments, service 614 is implemented by reporting system 612, while in others it is implemented separately therefrom. Communications between service 613 and reporting system 612, as well as between service 613 and utility service 614 in certain embodiments are conducted via network 606, while in others such communications are conducted via a different communication medium.

In certain advantageous embodiments, multiple reporting systems distribute reporting services among multiple network nodes at which reporting entities or customers of reporting entities produce either standardized or customized reports from micro-level report objects obtained from multiple participating user systems, such as user system 104. In such embodiments, the micro-level report objects are implemented as network-mobile objects capable of being communicated to multiple, distributed reporting nodes and assembled into either standard macro-level reports constructed from multiple micro-level report objects, or custom-created macro reports assembled from micro-level report objects using whatever parameters the reporting entity or customer may wish to choose. Further details of exemplary reporting systems and other operational features may be found in U.S. Pat. No. 7,627,872 to Hebeler et al., titled “Media Data Usage Measurement and Reporting Systems and Methods” issued Dec. 1, 2009, which is assigned to the assignee of the present application and is incorporated by reference in its entirety herein.

In certain embodiments service 613 may be integrated into system 604 or may be implemented by means of a dedicated device as a peripheral of the user system 604 or as a board or other device inserted within the user system 604 or otherwise coupled therewith. In such embodiments the service 613 preferably, but not necessarily, is implemented by a device which also implements the processor 607. In other embodiments the service 613 is implemented in software running on the user system, and loaded therein from the network 106 or other communication medium, or from a storage medium.

An embodiment of the object transmission/reception service 613 is illustrated in FIG. 6A. In use to communicate a micro-level report object 611 to the reporting system 612, an object serialization process 620 of service 613 serializes micro-level report object 611 into data capturing all identity, state and behavior of the object 611. While any serialization technique may be implemented by process 620, in certain embodiments the process 620 employs a binary object serialization technique that translates the identity, behavior and state of object 611 into a binary data stream. In other embodiments, the process 620 performs a Simple Object Access Protocol (SOAP) compliant serialization of the object 611. In further embodiments, an HTTP request/reply protocol is employed. Preferably, but not necessarily, process 620 supports multiple serialization algorithms to facilitate communication with various reporting systems 612 as well as with one or more utility services 614. An object compression/decompression process 624 subjects the serialized object 611 to no-loss compression, in accordance with any appropriate technique. Preferably, but not necessarily, process 624 supports multiple compression algorithms to facilitate communication with various reporting systems 612 and one or more utility services 614.

An exemplary encryption/decryption process 628 may encrypt compressed object 611 by means of any technique providing sufficient security to preserve the integrity of the report object 611 by protecting it against tampering and user manipulation. As in the case of process 620 and 624, it is preferable, but not necessary, that process 628 implement multiple encryption algorithms to facilitate communication with various reporting systems 612 and one or more utility services 614. Alternately, or in addition, object obfuscation/deobfuscation 630, described above, may be performed on report object 611. Object transmission/reception process 632 may to establish communication with the reporting system 612 and/or the utility service 614 via network 606 or other communication medium. Where the object transmission/reception service 613 communicates with the system 612 via the Internet, or other TCP/IP network, for example, the process 632 implements the TCP and IP layers and maintains the connection with the reporting system 612 and one or more utility services 614. Preferably, but not necessarily, the process 632 supports multiple communications protocols to facilitate communications with reporting system 612 and one or more utility services 614. In certain embodiments, one or more of processes 620, 624, 628 and 632 of service 613 may be utilized by other applications running on user system 604 for communications, while in other embodiments the processes 620, 624, 628 and 632 are utilized only for communications to/from processor 607, including transmission of micro-level report objects 611.

As noted above, object transmission/reception service 613 supports bi-directional communication by the processor 607. In certain embodiments, this capability is employed to obtain from utility service 614 updates to the objects 608, 610 and 611 as well as to add new objects and object classes, such as new types of media data usage gathering objects for monitoring usage of new or different types of media data and/or user agents. Preferably, but not necessarily, processor 607 receives such updates and new objects from a single utility service 614 which supplies the same to all media data monitoring processors in all user systems which cooperate to provide reports of media data usage to the reporting system 612. The communications from utility service 614 preferably are implemented by a transmission service corresponding to service 613. Accordingly, such communications when received by service 613 are first received by the object transmission/reception process 632 implementing the appropriate communication protocol and then decrypted by process 628 and decompressed by process 624. Then the decompressed communication is reconstituted by process 620 for use by processor 607.

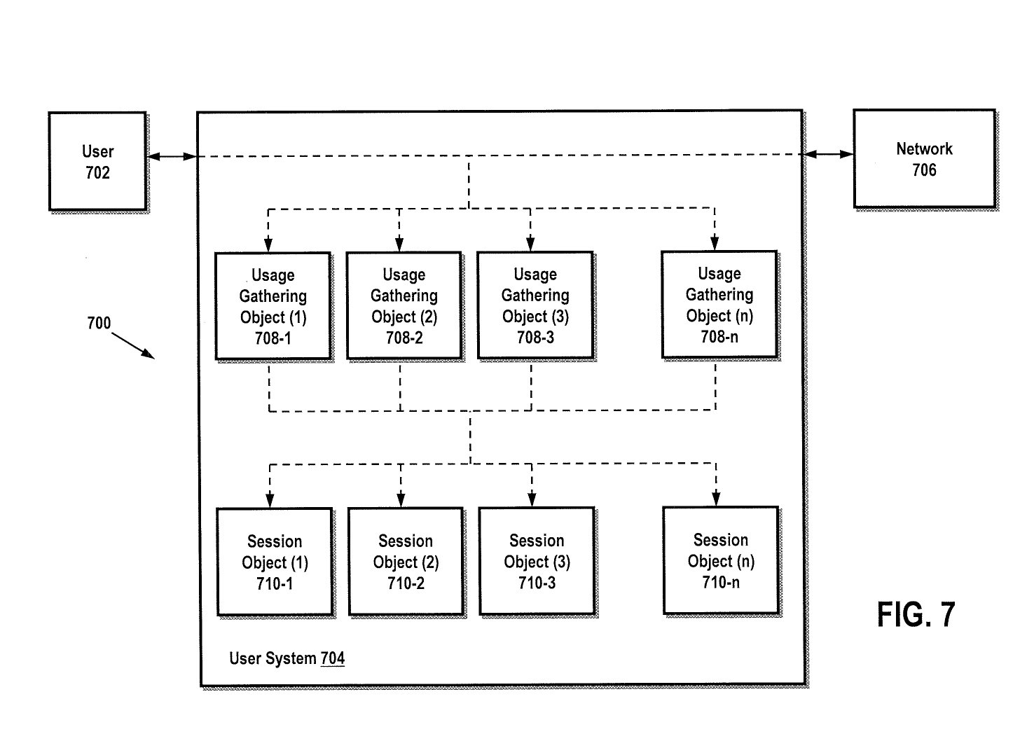

FIG. 7 illustrates a further media data usage system 700 in which a user 702 is presented with or accesses media data by means of a user system 704. User system 704 may be connected to a network 706 in order to access or present the media data to the user 702. User system 704 also incorporates a local source of media data (not shown for purposes of simplicity and clarity), corresponding to local source 605 of FIG. 6. User system 704 may incorporate a media usage monitoring processor and an object transmission/reception service (not shown for purposes of simplicity and clarity) corresponding to processor 607 and service 613 of FIG. 6. In addition, the processor incorporated in user system 204 serves to create and manage multiple instances of media data usage gathering objects (708-1 to 708-n) corresponding to object 608 of FIG. 6 which run concurrently and/or at various differing times in order to track usage of different respective media data types and/or user agents. For example, if user 702 opens a browser, in certain embodiments the processor instantiates a browser usage data gathering object to track its usage. If an audio and/or video player is also opened while the browser is in use, the processor instantiates a player usage data gathering object to track its usage separately from the browser. Similarly, if an audio detection application is activated, audio codes and/or signatures are collected and aggregated into one or more audio detection gathering object. The same is also done in order to track usage of other types of user agents such as a chat application.

In further embodiments, separate usage gathering objects track usage of different media data. For example, one object will track use of a web page while one or more other objects will monitor advertisements which run within or appear in separate pop-up and/or pop-under windows. In still further embodiments, one set of objects tracks usage of different types of user agents while others monitor usage of multiple respective media data presented by means of a single user agent. The usage monitoring system, therefore, automatically gathers data concerning usage of multiple different media data types and/or user agent types into different respective objects, so that the gathered data is easily accessible by type of media data used or user agent employed.

The processor is also capable of creating and managing multiple instances of session objects (710-1 to 710-n) which run concurrently and/or at various different times in order to merge appropriate ones of the objects (708-1 to 708-n) into respective user sessions. Each such object gathers media data usage data into objects each representing activity during a respective user session, and thus serves to pre-process this data to facilitate preparation of media usage reports at a later stage. Excess processing, storage and communication bandwidth resources of the user system 704 are thus utilized to produce session objects arranging usage data by session, media data type and/or user agent type. The session objects then are analogous to building blocks that may be assembled efficiently into any number of reports each structured as desired according to selected reporting parameters. The structures of the reports may be standardized or designed on an ad hoc basis to best serve the needs of a user of the reporting system. Preferably, processor 607 and service 613 track the ongoing extent to which user system and communication resources are being used in order to adjust their demands on these resources to avoid interference with other applications and communications employed by the user. As in the embodiments of FIG. 6, the session objects are merged into micro-level report objects for communication to one or more reporting systems (not shown for purposes of simplicity and clarity) and these reports may be transmitted via P2P network.

Using techniques described herein, it can be seen that, in addition to audio signatures and codes, most types of content accessed on a device and used for audience measurement purposes may be distributed securely with privacy protection. Thus, items like ad impressions, ad verification, click measurement, digital video ad measurement, mobile web advertisement, rich media and/or rich internet applications, described by the Interactive Advertising Bureau (IAB) guidelines (http://www.iab.net/guidelines) may be utilized.

Although various embodiments of the present invention have been described with reference to a particular arrangement of parts, features and the like, these are not intended to exhaust all possible arrangements or features, and indeed many other embodiments, modifications and variations will be ascertainable to those of skill in the art. For example, while embodiments were disclosed relating to media data and content, other embodiments are envisioned where panelist purchase data, panelist metadata, and other forms of data capable of having an individualized identification are processed in the aforementioned network.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of communicating in a computer-based network, comprising the steps of:
identifying user data having one or more predetermined characteristics;
requesting a session for a peer-to-peer network connection to each of the processing devices identified with associated user data having the one or more predetermined characteristics;
forming a peer-to-peer network with processing devices responding to the request, where each of the processing devices are configured to act as a node on the formed network and communicate with each other; and
receiving collected exposure data from the formed network reflecting exposure to media at each of the nodes, wherein the exposure data comprises at least one of audio signatures and Internet usage.

2. The method according to claim 1, wherein the exposure data is at least partially obfuscated.

3. The method according to claim 1, wherein the user data comprises one of age, sex, income, marital status, panelist demographics, previous exposure to media, retail store visits, purchases, previous internet usage, consumer beliefs and opinions relating to consumer products and services.

4. The method according to claim 1, wherein the audio signatures comprise transformed acoustic energy that identify or characterize at least one of a program, song, station, channel and commercial that was watched or listened to by a panelist.

5. The method according to claim 1, wherein the audio signatures comprise a time-based component that identifies of characterizes at least one of a program, song, station, channel and commercial that was watched or listened to by a panelist.

6. The method according to claim 1, wherein the exposure data for Internet usage comprises data objects collected from the processing device.

7. The method according to claim 2, wherein the obfuscation is based on at least one of lexical obfuscation, data obfuscation, control obfuscation and layout obfuscation.

8. The method according to claim 7, wherein the obfuscation transforms network flow data, from each of the processing devices, to be unreadable.

9. The method according to claim 7, wherein the obfuscation transforms user data, from each of the portable devices, to be unreadable.

10. An article comprising a machine readable tangible medium having embodied thereon a computer program, the computer program being executable by a computer included in a peer-to-peer network system comprising a plurality of portable device, the computer program being executable by the computer to perform:
identifying user data having one or more predetermined characteristics;
requesting a session for a peer-to-peer network connection to each of the processing devices identified with associated user data having the one or more predetermined characteristics;
forming a peer-to-peer network with processing devices responding to the request, where each of the processing devices are configured to act as a node on the formed network and communicate with each other; and
receiving collected exposure data from the formed network reflecting exposure to media at each of the nodes, wherein the exposure data comprises at least one of audio signatures and Internet usage.

11. The article according to claim 9, wherein the exposure data is at least partially obfuscated.

12. The article according to claim 10, wherein the user data comprises one of age, sex, income, marital status, panelist demographics, previous exposure to media, retail store visits, purchases, previous internet usage, consumer beliefs and opinions relating to consumer products and services.

13. The article according to claim 10, wherein the audio signatures comprise transformed acoustic energy that identify or characterize at least one of a program, song, station, channel and commercial that was watched or listened to by a user.

14. The article according to claim 10, wherein the audio signatures comprise a time-based component that identifies of characterizes at least one of a program, song, station, channel and commercial that was watched or listened to by a user.

15. The article according to claim 10, wherein the exposure data for Internet usage comprises data objects collected from the processing device.

16. The article according to claim 11, wherein the obfuscation is based on at least one of lexical obfuscation, data obfuscation, control obfuscation and layout obfuscation.

17. The article according to claim 16, wherein the obfuscation transforms network flow data, from each of the portable devices, unreadable.

18. The article according to claim 16, wherein the obfuscation transforms user data, from each of the portable devices, unreadable.
